(19) United States
(12) Patent Application Publication
(10) Pub. No.: US 2008/0218609 A1
(43) Pub. Date: Sep. 11, 2008

(54) Cross-coupled differential Dac-based black clamp circuit

(75) Inventors: Laurent Blanquart, Westlake Village, CA (US); Joey Shah, Thousand Oaks, CA (US); John Richardson, Newbury Park, CA (US)

Correspondence Address: REED SMITH, LLP, TWO EMBARCADERO CENTER, SUITE 2000, SAN FRANCISCO, CA, 94111, US

(73) Assignee: AltaSens, Inc.

(21) Appl. No.: 11/715,798

(22) Filed: Mar. 7, 2007

(51) Int. Cl. H04N 9/64

(52) U.S. Cl. 348/243; 348/294; 348/E09.001; 348/E09.051

(57) ABSTRACT

A black clamp circuit for an image sensor utilizes a differential programmable gain amplifier and a feed-back loop to adjust a black level based on comparison to a reference black level. The gain (and therefore step size and range) of the feed-back loop constant for all programmable gain amplifier gain settings. The gain of the fee-back loop is kept constant by adjusting the values of programmable capacitors in the circuit.

### BACKGROUND OF THE INVENTION

1. Field of the Invention

The present invention relates generally to image processing for electronic imaging sensors, and more particularly, to an apparatus and method for stabilizing the black level of electronic image signal produced by an image sensor.

2. Description of the Related Art

Modern color cameras typically use solid state image sensors such as a charge-coupled-device (CCD) or a CMOS Image Sensor (CIS) to capture still images or generate video. It is important that the signal from these sensors has a stable black level. Black-level clamping enables photographs and video to consistently produce quality images regardless of gain (or equivalent ISO speed), scene content and scene illumination. Adjustment circuits providing such capability have previously been referred to as video black clamp, black restoration or DC coupling reduction circuits. Instability in black translates to degradations in image quality resulting in “washed out” or dim pictures, and flickering video. Rapid black-level convergence can help “capture the moment” at a moment's notice.

The video component of a transmitted television signal is typically characterized by its average brightness, i.e., transmitted DC level, and overall dynamic range. The signal that is to be reproduced in a television receiver, for example, must have proper brightness along with a black level that is constant regardless of scene content and scene-to-scene dynamics. The resulting signal should also fully span the dynamic range of the intended display regardless of the camera gain used to maintain brightness.

In early camera technology, black clamping or restoration was performed ex post facto. Since early video cameras required DC blocking circuits to circumvent technology limitations, television receivers had to fix the errors related to DC blocking in order to prevent major video degradation via buildup of systematic DC shifts. U.S. Pat. No. 4,338,630 discloses a single-chip chroma/luma integrated circuit that facilitates black clamping via dynamic DC restoration in the television receiver, rather than at the source of video origination. A DC restoration circuit clamped to a fixed black level is said to be characterized by 100% DC coupling. However, it is often desirable to decrease DC coupling by varying the clamping level to compensate for broadcast transmission inconsistencies. Although U.S. Pat. No. 4,338,630 facilitated black “clamping” in a single integrated circuit, each receiver behaved differently depending on user setting of black level and contrast.

Black level processing in a color video camera is exemplified by U.S. Pat. No. 4,680,624, which teaches black level clamping and video production wholly in the analog domain (FIG. 1). The objective of in-camera black clamping is to simplify the video processing that must subsequently be performed in the television receiver. Specifically, the low-noise video circuit dynamically clamps the black level produced by the image pickup element by comparing the sampled signal to a reference voltage and correcting the offset by negative feedback. The circuit also maximizes black level quality by: 1) superimposing a compensating signal to approximately correct the horizontal shading generated by the image pickup; and 2) adjusting video gain to tune the amplitude of the carrier chrominance signal in proportion to the luminance to minimize color noise in the black reference and thereby further improve black clamp efficacy.

Nevertheless, the '624 circuit uses bandpass filters and quadrature detectors to strip the luminance signal from the base band signal so that the video is actually decomposed prior to being reassembled for broadcast or broadband transmission. Furthermore, the shading correction is empirically supplied based on general characteristics rather than dynamic customization. Depending on errors in estimating the necessary shading correction and other real-time errors, the qualitative shading compensation can generate pulsation or flashing in the televised image. Consequently, an alternative black clamp correction circuit that is out of the feedback loop is also taught in '624, but with concomitant stability issues.

U.S. Pat. No. 4,974,072, No. 5,189,528, and No. 5,038,225 represent black clamping circuits specifically developed to support the special needs of solid state sensors. Each uses black reference data stored during a calibration period to correct and stabilize the black level. In U.S. Pat. No. 4,974,072, as a case in point, the circuit independently corrects the black level for each line sensor within a plurality of sensors; different black level correction is hence applied to each sensor to compensate for differing levels of electrical feed through crosstalk. Nevertheless, application to video sensors is problematic unless a mechanical shutter is available.

U.S. Pat. No. 5,341,218 teaches an improved black clamping circuit specifically intended for video applications. A major improvement is the use of dedicated black reference pixels to dynamically determine the black video level. The circuit further improves black clamping efficacy by digitally averaging the reference data over a plurality of fields or frames. However, analog corrections to the black clamp level are applied only during the vertical blanking period using dedicated sample-and-hold. Horizontal shading non-uniformity generated by the imaging sensor is hence not corrected. Perhaps more importantly, the circuit cannot adapt to different analog gain so that changing analog gain will disrupt black clamp convergence.

U.S. Pat. No. 5,659,355 improves on the '218 patent by adaptively accommodating variable analog gain, in that the programmable gain is switchable to successively handle black pixels followed by active pixels (FIG. 2). Black-level clamping is determined digitally and then applied via analog means. While the black reference levels are digitized during the “front porch” of each video line of the analog signal produced by a solid state charge coupled device (CCD) image sensor, a D/A converter generates the analog correcting signal that is supplied to a differencing amplifier located at the input of the gain stage. The upgraded feedback loop comprises a variable gain stage, A/D conversion, a digital accumulator, the D/A converter and the precision differencing amplifier. However, the process of dynamically changing the gain can be a source of errors in the black level, especially at higher video rates, and the DAC supplies a single-ended signal that must be trimmed and carefully handled to maximize accuracy.

In U.S. Pat. No. 6,940,548, black clamping is moved entirely back to the analog domain by performing signal processing prior to A/D conversion. The standard programmable amplifier (with very wide gain range) is split into two PGAs each having narrower gain range. Consequently, the reverse programmable gain amplifier (RPGA) that subsequently calculates the difference between the actual and desired black values also has narrower range of gain reduction. Since the gains of both the direct programmable amplifier and the reverse programmable amplifier are modified using capacitor ratios, the RPGA, which is located in the black clamp loop, has a more practical range compatible with better device matching and higher production yield. Nevertheless, five analog components (PGA1, PGA2, RPGA, Integrator and Difference amplifier) must accurately complement each other with respect to behavioral characteristics across process and operating temperature variations to maximize black stability.

### SUMMARY OF THE INVENTION

In one embodiment of the present invention, a black clamp circuit has a programmable gain amplifier and a feed-back loop wherein a gain in the feed-back loop is kept constant for all programmable gain amplifier gain settings by adjusting a programmable capacitive network.

More particularly, a black clamp circuit of the present invention may comprise a differential programmable gain amplifier, a programmable capacitive network attached to the programmable gain amplifier, an analog-to-digital converter connected to an output of the programmable gain amplifier, a digital-to-analog converter connected to an input of the programmable gain amplifier, and a controller connected to the analog-to-digital converter and to the digital-to-analog converter, wherein the controller compares a signal from the analog-to-digital converter with a black reference value, and outputs a control signal to the digital-to-analog converter based on a result of comparing the signal from the analog-to-digital converter with the black reference value.

The capacitive network may comprise a plurality of programmable capacitors. For example, the circuit may include a programmable black clamp capacitor C_{bc}, a programmable signal capacitor C_{sig} and a programmable feedback capacitor C_{f}.

The digital-to-analog converter may comprise two digital-to-analog converters connected in tandem. One digital-to-analog converter handles coarse adjustments, and the other handles fine adjustments.

In another embodiment of the invention, a method includes receiving a data stream of optical black reference pixel signals, inputting the data stream to a terminal of a differential programmable gain amplifier, comparing an output signal from the programmable gain amplifier with a black reference value, outputting a control signal based on the comparing, and setting a programmable digital-to-analog converter with the control signal in order to adjust an input to the programmable gain amplifier.

The method may further include processing active pixel signals after setting the black level. Additionally, the method may include setting a gain of the programmable gain amplifier for each color of a color filter array corresponding to each active pixel signal. In a further embodiment, the method includes adjusting programmable capacitors to set the gain of the programmable gain amplifier, such that a loop gain is kept constant for all programmable gain amplifier gain settings.

A black clamp circuit according to the present invention may be incorporated into an image sensor having an array of active pixels, and a plurality of optical black pixels. The optical black pixels are processed by the black clamp circuit in order to set an appropriate black level for the active pixels.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a schematic circuit diagram of a prior art circuit disclosed in U.S. Pat. No. 4,680,624;

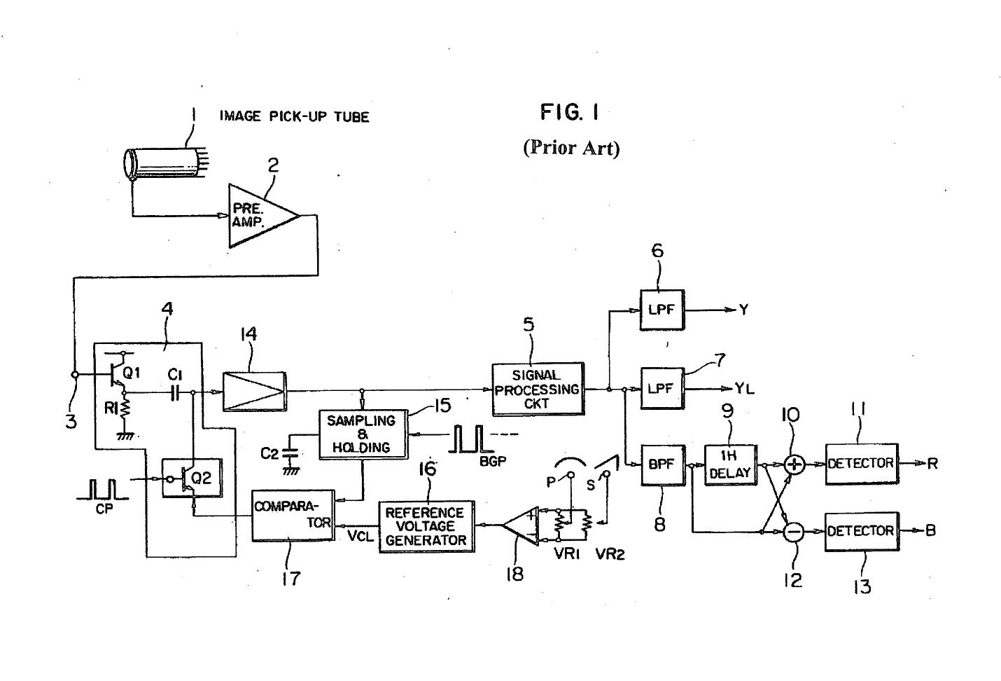

FIG. 2 is a schematic circuit diagram of a prior art circuit disclosed in U.S. Pat. No. 5,659,335;

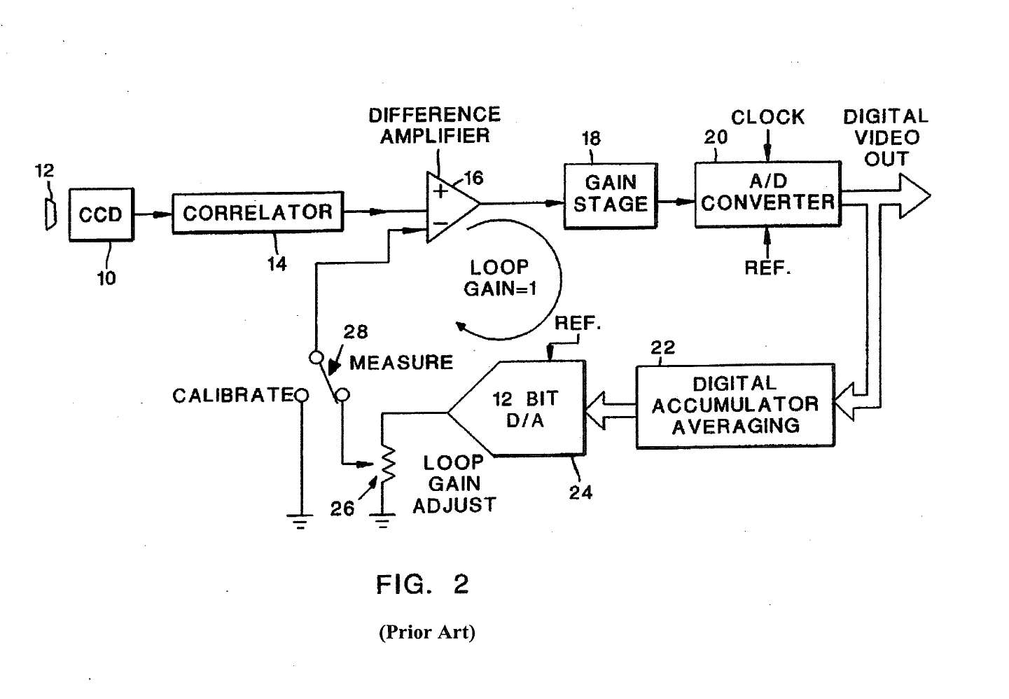

FIG. 3 is a block diagram showing a representative embodiment of a sensor array including active pixels, black reference or optically black (OB) pixels, dummy pixels and guard bands;

FIG. 4 is a table articulating the structure of the sensor array partitioned in FIG. 3 and shown in schematic circuit form in FIG. 6;

FIG. 5 is a schematic circuit diagram illustrating an imaging System-on-Chip sensor incorporating the key circuit elements of the black-clamping system of the present invention;

FIG. 6 is a diagram of the imaging System on Chip data stream that specifically shows the output of the black reference pixels and the time intervals for updating the sensor's black reference level;

FIG. 7 is a schematic circuit diagram illustrating an embodiment of the black-clamping system of the present invention

FIG. 8 is a schematic circuit diagram illustrating a preferred embodiment of an imaging System-on-Chip incorporating the black-clamping system of the present invention; and

FIG. 9 is a schematic circuit diagram illustrating a preferred embodiment of an imaging System-on-Chip sensor incorporating the black-clamping system of the present invention;

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

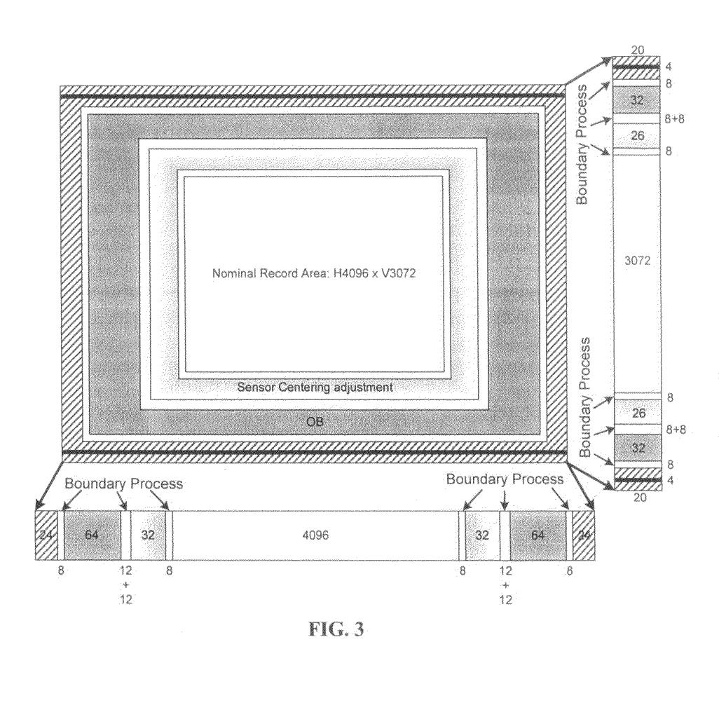

The present invention includes an exemplary design for an active-pixel CMOS imager. A prototype embodiment of the low-noise APS invention can support, for example, a visible imager comprising an active array of 4096 (columns) by 3072 (rows) of visible light detectors (photodetectors). This nominal record area is bounded by a contingent of black reference pixels in the surrounding periphery of the active array. FIG. 3 shows a representative layout for an image sensor of the present invention focusing specifically on the nominal record area or active imaging region, a perimeter of optical black (OB) pixels, guard band pixels, dummy pixels, and optical alignment pixels.

The rows and columns of pixels can be spaced 4 microns center-to-center using 0.18 μm design rules to provide as-drawn optical fill factor of ˜50%. Several columns and rows of detectors at the perimeter of the light-sensitive region are normally covered with metal and other opaque materials to form optically black pixels. Constantly reading the OB pixels enables the present invention to determine and update the dark level to facilitate low-noise black clamping operation. In addition, the detectors in each row can be covered with color filters to produce color imagers. For example, the odd rows may begin at the left with red, green, then blue filters, and the even rows may begin with blue, red, then green filters, with these patterns repeating to fill the respective rows. A standard Bayer filter pattern can also be applied.

The video signal from the active pixel sensor hence includes:
a first interval of black level pixels comprising at least a portion of the Optical Black (OB) border surrounding the active imaging region
a second interval of active image pixels comprising the bulk of the video stream
optionally, a third interval of OB pixels

It is not required to read the various data at a specific time. For example, all black read pixels can be read in the “front porch” of the data or video stream including data from the black and active pixels of each line of the imaging sensor. The active pixels are normally read during a continuous interval that is preceded first by a “front porch” and followed by a “back porch” as defined by various timing standards such as, e.g. SMPTE 274M for high definition video. In both cases, the term “porch” refers to a timing interval during each video line, field or frame, wherein actual imaging data is not being supplied to the camera so that overhead signal processing functions can be supported. The relevant black pixel data can all be read during the front porch, split between the front porch and back porch, or read entirely during the back porch. Furthermore, while the OB data stream is supplied to the digital controller that supervises all operations in the imaging System-on-Chip (iSoC), it can also be supplied to the camera in the data stream along with the data from the active imaging array area.

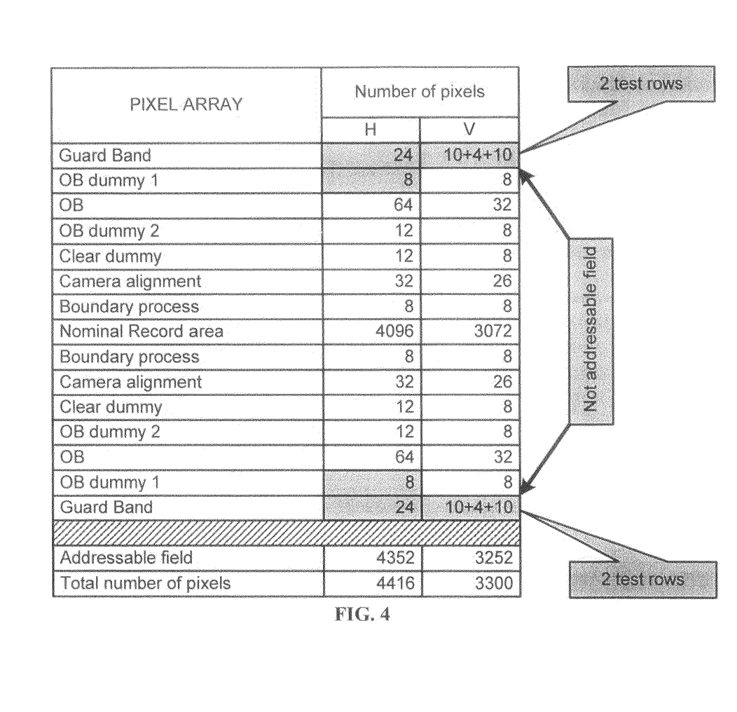

The table in FIG. 4 further articulates the composition of active and supporting pixels in both the horizontal and vertical directions for a typical embodiment. In the horizontal direction, for example, a sensor supporting a base resolution of 4096 by 3072 pixels actually encompasses a grand total of 4416 by 3300 pixels of which 4352 by 3252 are addressable for readout. The additional rows and columns along the perimeter are required to enhance image quality via electrical isolation and iSoC image processing. Specifically, the pixels adjacent to the surrounding iSoC circuits constitute a guard band that is 24 pixels in width or a distance of about 100 μm (i.e., 4 μm×24 pixels) to isolate the electronic circuit functions from photoelectrical operation. The primary function of guard band pixels is to block indirect light or stray photogenerated carriers from reaching the electronic circuits via the substrate since the free carrier absorption length in silicon is about 100 μm. Another key objective is to prevent iSoC operation in the peripheral electronic circuits from corrupting the signal in OB and clear pixels. Next in the pixel arrangement are various sets of OB pixels including a first dummy region (OB dummy 1) spanning 8 pixels, 64 clear OB pixels used for black clamping and other signal processing functions, a second OB dummy region comprising 12 pixels, 12 clear dummy pixels to separate OB from active, 32 fully active pixels useful for compensating for sensor-to-camera misalignment by accordingly shifting the nominal record area, 8 boundary process pixels also used for special signal processing operations, the main contingent of 4096 fully active pixels, and a matching set of supporting pixels on the opposite side of the nominal record area.

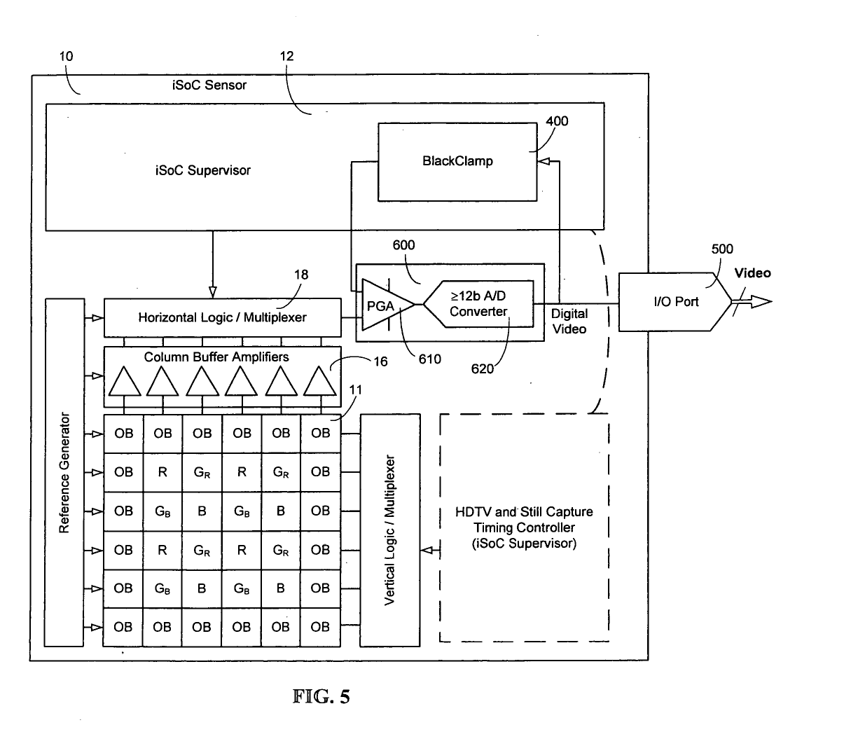

In a preferred embodiment, the pixel array shown in FIG. 3 and tabulated in FIG. 4 is embedded within the imaging System-on-Chip architecture 10 of FIG. 5. Rather than showing the full embodiment comprising 4416 by 3300 pixels, a smaller six-by-six pixel array block 11 is shown for clarity including an OB border having width of only one pixel. Pixel block 11 is read through column buffer amplifier block 16 and multiplexed into a serial video stream by horizontal multiplexing logic 18. Column buffer block 16 can use the methodology taught by U.S. Pat. No. 5,892,540. The serial video stream includes both OB and photo-generated pixel data. The OB reference data further comprises a stream of OB pixels averaged over a programmable number of OB rows and/or OB columns to both accurately determine and dynamically adjust the black reference level.

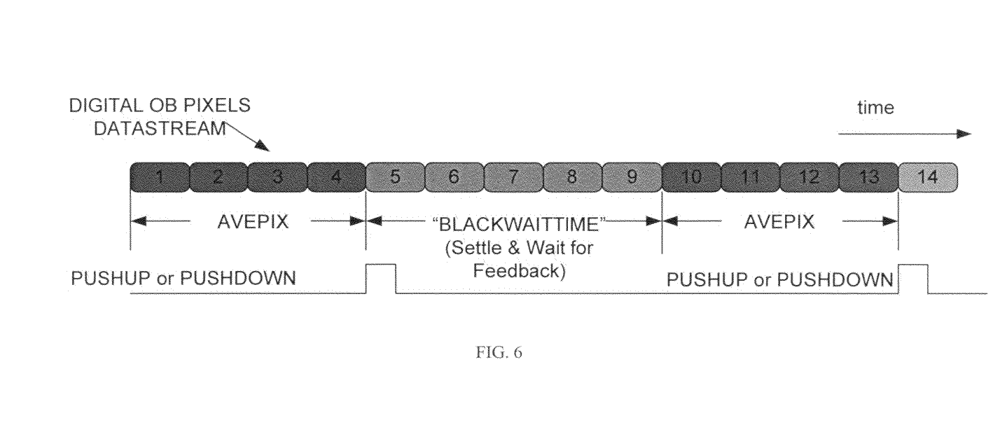

In FIG. 6, for example, a basic pixel stream includes 4 black pixels, followed by a programmable time interval denoted BLACKWAITTIME, and a second set of 4 black pixels. The epoch spanning the first group of 4 black pixels is labeled AVEPIX and refers to the number of OB pixels used to average the OB information. The BLACKWAITTIME is used to perform signal processing operations on the data in the intervening clock cycles. Shown is the ability to “push up” or “push down” the active video by incrementing or decrementing the black level (PUSHUP or PUSHDOWN) just after reading each OB segment. The correction is allowed to settle during the programmable BLACKWAITTIME and/or after the second OB block is read. BLACKWAITTIME also allows for data that was using the old OB correction value already in the ADC pipeline to empty out so that only data with the new correction value is used in the next average. After subsequently reading a second set of OB pixels, a second “push down” or “push up” correction further adjusts the black reference level at this time. Hence, the iterative process of reading OB pixels, adjusting the black reference level, reading additional OB pixels, and then readjusting the black reference level enables the black clamp feedback loop to accurately converge to the appropriate black reference target prior to the actual time that the first active video enters the iSoC video stream. The iterative process also prevents transients from adversely disturbing the black reference level generated by the black-clamping loop.

Referring again to FIG. 5, the black clamp of the present invention is realized by re-architecting the iSoC components of block 600 including programmable gain amplifier 610 and A/D converter 620, which digitizes the composite data stream at minimum resolution of 12 bits. This digitized data stream is subsequently supplied to the logic operator represented by black clamp block 400 to perform the necessary signal processing operations to provide accurate correction values to cross-coupled PGA 610.

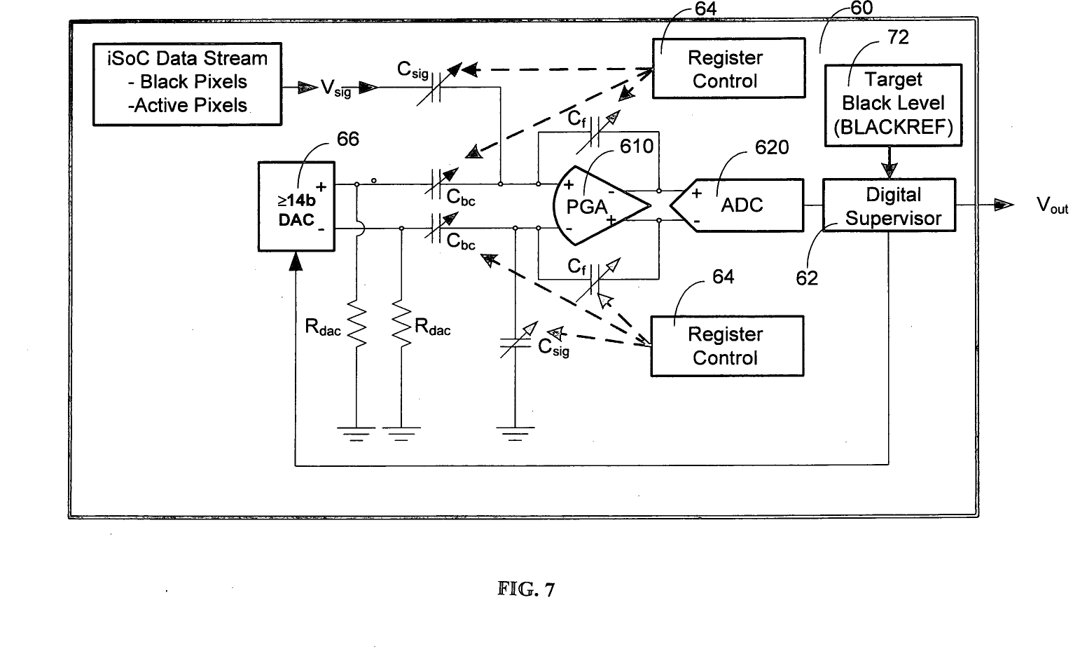

In the present invention the circuit blocks of block 600, including PGA 610 and ADC 620 are assembled in a cross-coupled architecture as shown in FIG. 7. Cross-coupled PGA 610 and ADC 620 are supplemented by DAC 66 and digital supervisor block 62. Generally, the ADC 620, the digital supervisor 62 and the DAC 66 form a feed-back loop, with the PGA 610, for adjusting the black level.

An incrementing signal is applied to the positive leg of the dual input PGA 610 and a decrementing signal is applied to the inverting leg. This cross-coupling enables smooth black reference adjustment by segregating positive and negative corrections. In this specific embodiment of the present invention, the single DAC 66 provides at least 14-bit resolution to accurately provide fine adjustment during normal operation, while also supporting coarse adjustment over a much larger overall range to accommodate either long-term operation over wide temperature range or process variation in production. A programmable capacitive network, formed by adjustable capacitors C_{sig}, C_{bc} and C_{f}, allows the gain of the amplifier to be changed, as controlled by the register control 64.

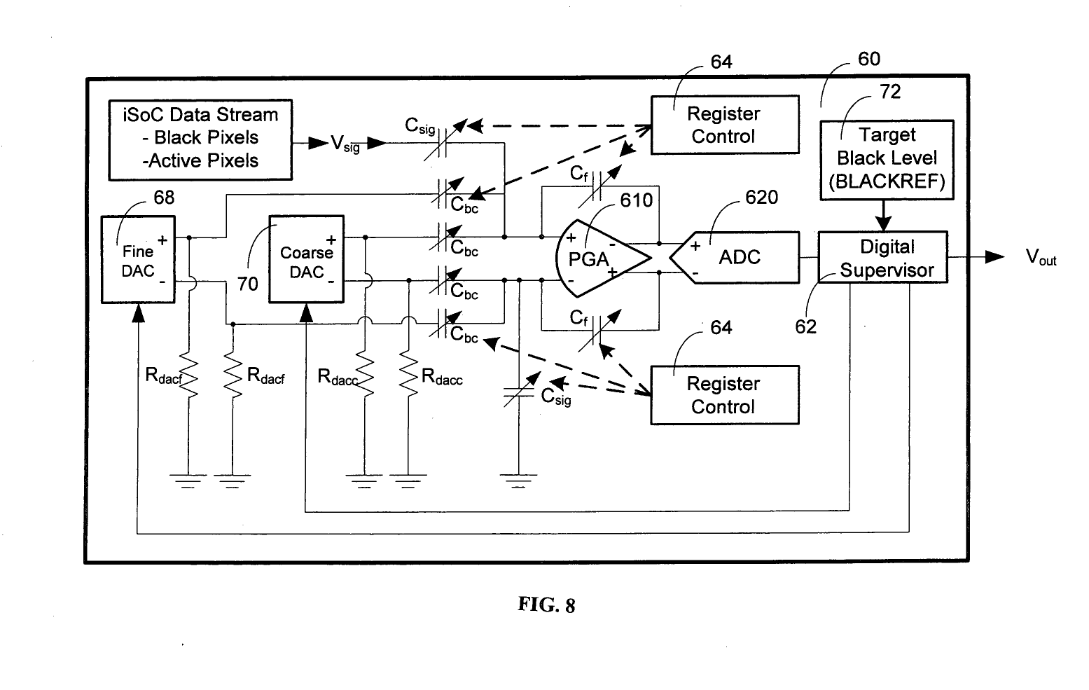

FIG. 8 illustrates a preferred embodiment of the DAC-based black clamp. Here, two DACs are used in tandem to sustain fine and coarse adjustment of the black clamp correction terms. The coarse and fine correction voltages are supplied to PGA 610 through identical coupling capacitance, C_{bc}. The PGA 610 employs programmable feedback capacitors, C_{f}, whose values are programmed by a register control 64. The PGA gain is thus appropriately programmed to accommodate the specific gains that required for each color to optimally fine-tune white balance and colorimetry. An image sensor with a color filter array requires separate gains for the R, G, and B channels. Furthermore, best practices mandates that a Bayer-patterned sensor uses separate gains for each of the four color channels that are each processing G_{R}, G_{B}, R or B pixels. This latter capability recognizes that the green channel behavior for green pixels in each row of Bayer-patterned pixels comprising red and green pixels is not identical to the green channel behavior for the green pixels within a row comprising green and blue pixels. Green pixels in a row of red and green pixels is thus often distinguished and labeled as a G_{R} pixel. A green pixel in a row consisting of green and blue pixels is similarly considered to be a G_{B} pixel.

The register control block 64 thus may have pre-programmed gain settings for a given image sensor's color filter array, and/or may be dynamically adjusted based on settings from the camera.

The preferred embodiment using tandem DACs 68, 70 better supports the diverse CMOS processes supported by various CMOS foundries. While the disclosed preferred embodiment uses two 8-bit DACs to obtain ⅛ LSB resolution at the output of the PGA, those skilled in the art will appreciate that other combinations of DAC resolutions are useful. By using a coarse DAC in combination with a fine DAC, the scheme enables separating relatively large offsets as constants that are not changed during normal operation. Instead, the fine DAC is most active after initial start-up of the sensor. The overlapping coverage provided by two DACs also better maintains the monotonicity needed for optimum black clamp operation.

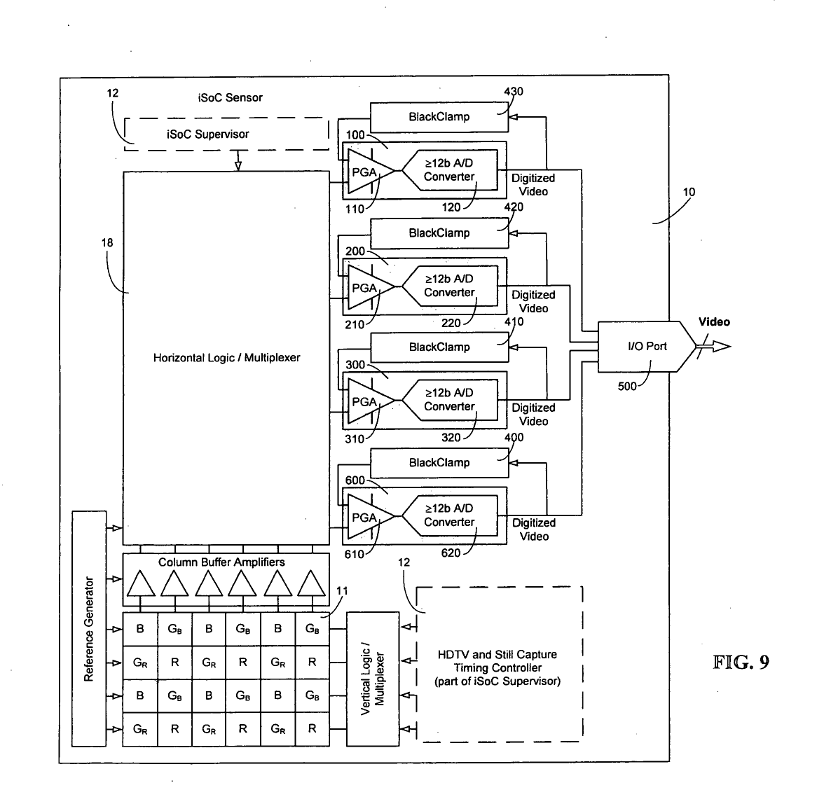

The iSoC data stream including reference and active pixel data are supplied to the input of PGA 610 whose gain is set, on a pixel-by-pixel or channel-by-channel basis, by iSoC register control 64. The final outcome is that the resulting output signal from the digital controller is dynamically governed to generate the output signal:

$${V}_{out} = \frac{{C}_{sig}}{{C}_{f}} {V}_{sig} + \frac{{C}_{bc}}{{C}_{f}} {V}_{bc}$$

where Vₒᵤₜ is the output signal, V_{sig} is the active pixel signal, V_{bc} is the optical black pixel signal, C_{sig} is the capacitor setting for the active video, C_{bc} is the capacitor setting for the black clamp data stream and C_{f} is the base feedback capacitance. The present invention hence allows separate gain for the active and black pixels in addition to separate gain for each color. Those skilled in the art will appreciate that additional capacitors can be used to increase the total range of gain control including support for cross-coupled Digital-to-Analog Converter (DAC) 66. Those skilled in the art will also appreciate that four PGAs can be used to best handle the G_{R}, G_{B}, R and B channels. Then, for example, the G_{R}, G_{B}, R and B channels are subsequently recombined in the desired order in I/O port 500. The schematic diagram in FIG. 9 hence represents the preferred iSoC embodiment for incorporating the preferred black-clamping circuit of FIG. 7.

Referring once again to FIG. 7, the iSoC data stream is digitized by the Analog-to-Digital Converter (ADC) 68, which preferably provides a minimum resolution of 12 bits to maximize the accuracy of calculating all values. Digitized data is then supplied to digital supervisor 62 which compares the black level data to the target black level 72, BLACKREF. The digital supervisor 62 determines whether to shift UP or DOWN by some amount. The size of the shift can depend on the distance from the target using some algorithm, or may be a constant small shift. Using a DAC as the offsetting element allows for complete flexibility in how the output converges to the target.

From FIG. 7, the gain of the signal from the input to the output is equal to the ratio C_{sig}/C_{f}. To adjust this gain, the user changes the value of a programmable register in the chip which in turn adjusts the values of C_{sig} and C_{f}. Normally when C_{f} is adjusted, if C_{bc} is kept constant, the black clamp resolution at the output of the PGA 610 will be changed. This is illustrated in the example below. Assuming:
DAC Step Size at input of PGA (Noninverting terminal in FIG. 7)=S_{DAC}
DAC Step Size at PGA output=S_{DAC}*C_{bc}/C_{f}=S_{DACOUT}.
PGA gain=C_{sig}/C_{f}.
   Then, if C_{f} were to be reduced to increase the PGA gain, the step size of the DAC would be increased by the same factor as well.

For example, if S_{DACOUT} is 60 μV and the PGA gain is increased from 1 to 2 by decreasing C_{f} by 50 percent, S_{DACOUT} increases to 120 μV. This larger step can decrease the stability of the black reference and also increases the gain of the DAC noise to the output of the PGA.

One way to handle this is to have the DAC minimum step size chosen to work for the maximum PGA gain. Unfortunately at lower gains, this makes the convergence very slow since the step size is exceedingly small. This also makes the noise requirement on the DAC very difficult to meet, as will be described shortly. The digital algorithm could adjust itself for the different gain settings to take larger steps when the gain is lower. However, this is cumbersome and complicates the digital control circuitry needed to control the DAC and still does not address the issue of the high noise requirements on the DAC. Here we take a look at the noise requirements for a DAC in a system with a 12-bit ADC as an example:
Desired black clamp DAC resolution at input of ADC=⅛ of a count.
Desired black clamp range at input of ADC=½ of full range.
Assuming the ADC is designed for 2.0 V full swing, then 1 count is ˜488 μV, ⅛^{th} of a count is 61 μV and the DAC range is 1.0 V.
Maximum PGA gain is 18 dB (gain of 8).
   At 18 dB PGA gain, a 14-bit DAC is hence needed (1.0V/61 μV) to span 1.0 V with a step size of 61 μV. At 0 dB gain (i.e., C_{f} 8 times higher) the step size is reduced to 7.625 μV. To cover 1.0 V with this step size, a 17-bit DAC is needed. The noise of this DAC at the PGA output can consequently be no more than ½ of a count, or 3.8 μV since as C_{f} is reduced both the noise and step size are amplified by the same amount. Such low noise is very difficult to achieve. Introducing low pass filtering to the DAC output is one way to reduce the noise. This will, however, also reduce the DAC speed which will limit the speed of the black clamp algorithm since the algorithm must wait for the new DAC output to settle before continuing.

In the present invention, this issue is solved in a novel way by having the gain (and therefore step size and range) of the DAC-to-PGA loop constant for all PGA gain settings. The step size is kept constant by keeping the ratio C_{bc}/C_{f} constant by automatically adjusting C_{bc} whenever C_{f} is changed. In fact, both C_{bc} and C_{f} can share the same digital control signals by design. We now examine the previous example again using this scheme.

At 18 dB gain a 14-bit DAC is needed to cover 1.0 V at the PGA output with a step size of 61 μV. At 0 dB gain, both C_{f} and C_{bc} are reduced by 8 times. Since the ratio of C_{bc}/C_{f} is the same even though the PGA gain has changed, the step size is still 61 μV and the required DAC noise at the PGA output is now 30 μV instead of 3.8 μV. Therefore, a 14-bit DAC may be used for all gain settings. This method also eliminates the need for a difference stage since the subtraction is performed differentially using the PGA itself.

As mentioned above with respect to FIG. 8, two low resolution DACs 68, 70, one fine and one coarse together form a DAC with the necessary resolution and range to correct the black level out the output of the PGA 610. Each DAC 68, 70 has a different step size at the output of the PGA 610 by using different resistors and a different C_{bc}/C_{f} ratio between each DAC and the PGA output. This allows using two low resolution DACs, one with a large step size and one with a small step size set by the constituent resistors and capacitors used, whose outputs are summed to create one high resolution DAC. This method significantly reduces the DAC area, and possibly the power requirements.

For example a 14-bit current steering DAC would normally comprise 2¹⁴ or 16384 current elements. However, using this scheme, two 8-bit DAC's may be used instead, only requiring 512 current elements. In theory, only two 7-bit DACs are needed, however, in practice some overlap between the minimum step size of the coarse DAC and the full range of the fine DAC is needed to make sure that the output has no missing output values over process, temperature, etc.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A black clamp circuit comprising:
a differential programmable gain amplifier, having a positive input terminal and a negative input terminal, wherein the positive input terminal receives a data stream of black pixel and active pixel signals;
a programmable capacitive network attached to the programmable gain amplifier;
an analog-to-digital converter connected to an output of the programmable gain amplifier;
a digital-to-analog converter connected to an input of the programmable gain amplifier; and
a controller connected to the analog-to-digital converter and to the digital-to-analog converter, wherein the controller compares a signal from the analog-to-digital converter with a black reference value, and outputs a control signal to the digital-to-analog converter based on a result of comparing the signal from the analog-to-digital converter with the black reference value.

2. The black clamp circuit of claim 1, wherein the programmable capacitive network comprises:
a first programmable feedback capacitor connected between the positive input terminal and a negative output terminal of the programmable gain amplifier;
a second programmable feedback capacitor connected between the negative input terminal and a positive output terminal of the programmable gain amplifier;
a first programmable signal capacitor connected to the positive input terminal of the programmable gain amplifier;
a second programmable signal capacitor connected to the negative input terminal of the programmable gain amplifier;
a first programmable black clamp capacitor connected between the positive output terminal of the digital-to-analog converter and the positive input terminal of the programmable gain amplifier; and
a second programmable black clamp capacitor connected between the negative terminal of the digital-to-analog converter and the negative terminal of the programmable gain amplifier;
wherein the values of the first and second programmable feedback capacitors, the first and second programmable signal capacitors, and the first and second programmable black clamp capacitors are adjusted in order to set a gain of the programmable gain amplifier.

3. The circuit of claim 2, wherein a gain of a digital-to-analog converter to programmable gain amplifier loop is constant for all programmable gain amplifier gain settings.

4. The circuit of claim 3, wherein a ratio of black clamp capacitance to feedback capacitance C_{bc}/C_{f} is kept constant by automatically adjusting the black clamp capacitor C_{bc} whenever the feedback capacitor C_{f} is adjusted.

5. The circuit of claim 1, wherein the digital-to-analog converter comprises a fine adjustment digital-to-analog converter and a coarse adjustment digital-to-analog converter, wherein both the fine adjustment digital-to-analog converter and the coarse adjustment digital-to-analog converter are connected to the programmable gain amplifier, and wherein both the fine adjustment digital-to-analog converter and the coarse adjustment digital-to-analog converter receive a control signal from the controller.

6. The circuit of claim 2, wherein the control signal from the controller adjusts a black level of the circuit to match the black reference level.

7. The circuit of claim 2, wherein the analog-to-digital converter has a differential input connected to differential output terminals of the programmable gain amplifier.

8. The circuit of claim 4, wherein a positive output terminal of the digital-to-analog converter is connected to the positive input terminal of the programmable gain amplifier, and a negative terminal of the digital-to-analog converter is connected to the negative terminal of the programmable gain amplifier, such that the digital-to-analog converter applies an incrementing signal to the positive terminal of the programmable gain amplifier, and a decrementing signal to the negative terminal of the programmable gain amplifier.

9. The circuit of claim 2, wherein the digital-to-analog converter has at least 14-bit resolution.

10. The circuit of claim 5, wherein the fine and coarse digital-to-analog converters have at least 8-bit resolution.

11. The circuit of claim 4, wherein the gain of the programmable gain amplifier is programmed according to a separate gain setting for each color in a color filter array.

12. A method of setting a black level in an image sensor, the method comprising:
receiving a data stream of optical black reference pixel signals;
inputting the data stream to a terminal of a differential programmable gain amplifier;
comparing an output signal from the programmable gain amplifier with a black reference value;
outputting a control signal based on the comparing; and
setting a programmable digital-to-analog converter with the control signal in order to adjust an input to the programmable gain amplifier.

13. The method of claim 12, further comprising processing active pixel signals after setting the black level.

14. The method of claim 13, further comprising setting a gain of the programmable gain amplifier for each color of a color filter array corresponding to each active pixel signal.

15. The method of claim 14, further comprising adjusting programmable capacitors to set the gain of the programmable gain amplifier, such that a loop gain is kept constant for all programmable gain amplifier gain settings.

16. An image sensor comprising:
an array of active pixels, each pixel covered by a color filter;
a plurality of optical black pixels;
read-out circuitry to read out signals from the active pixels and the optical black pixels; and
a black clamp circuit connected to the read-out circuitry to set a black level of the image sensor, the black clamp circuit having a constant loop gain for different amplifier gain settings.

17. The image sensor of claim 16, wherein the black clamp circuit comprises:
a differential programmable gain amplifier, having an input terminal connected to receive a data stream of black pixel and active pixel signals;
a programmable capacitive network attached to the programmable gain amplifier;
an analog-to-digital converter connected to an output of the programmable gain amplifier;
a digital-to-analog converter connected to an input of the programmable gain amplifier; and
a controller connected to the analog-to-digital converter and to the digital-to-analog converter, wherein the controller compares a signal from the analog-to-digital converter with a black reference value, and outputs a control signal to the digital-to-analog converter based on a result of comparing the signal from the analog-to-digital converter with the black reference value.

18. The image sensor of claim 17, wherein the digital-to-analog converter comprises a fine adjustment digital-to-analog converter and a coarse adjustment digital-to-analog converter, wherein both the fine adjustment digital-to-analog converter and the coarse adjustment digital-to-analog converter are connected to the programmable gain amplifier, and wherein both the fine adjustment digital-to-analog converter and the coarse adjustment digital-to-analog converter receive a control signal from the controller.

19. The image sensor of claim 17, wherein the programmable capacitive network is adjusted for each gain setting of the programmable gain amplifier, in order to keep a loop gain constant in the black clamp circuit.

20. A black clamp circuit comprising:
a differential programmable gain amplifier, receiving a pixel data stream having active pixel and optical black pixel signals; and
a feed-back loop comprising:
a programmable capacitive network attached to the programmable gain amplifier;
an analog-to-digital converter connected to an output of the programmable gain amplifier;
a digital-to-analog converter connected to an input of the programmable gain amplifier; and
a controller connected to the analog-to-digital converter and to the digital-to-analog converter, wherein the controller compares a signal from the analog-to-digital converter with a black reference value, and outputs a control signal to the digital-to-analog converter based on a result of comparing the signal from the analog-to-digital converter with the black reference value;
wherein a gain in the feed-back loop is kept constant for all programmable gain amplifier gain settings by adjusting the programmable capacitive network.
